(19) United States
(12) Patent Application Publication
(10) Pub. No.: US 2019/0093918 A1
(43) Pub. Date: Mar. 28, 2019

(54) METHOD FOR CONVERTING A GAS BOILER INTO A LIQUID-FUEL BOILER

(71) Applicant: I.C.I. CALDAIE S.P.A., Zevio (IT)

(72) Inventor: Giovanni PISANI, Verona (IT)

(73) Assignee: I.C.I. CALDAIE S.P.A., Zevio (IT)

(21) Appl. No.: 16/133,920

(22) Filed: Sep. 18, 2018

(30) Foreign Application Priority Data
Sep. 25, 2017 (IT) 102017000106687

(51) Int. Cl. F24H 1/14; F23D 11/00; F23Q 3/01; F24H 1/00; F27D 99/00

(52) U.S. Cl. CPC F24H 1/145; F23D 11/002; F27D 99/00; F24H 1/0027; F23Q 3/01

(57) ABSTRACT

A method for converting a gas boiler into a liquid-fuel boiler. The gas boiler comprises an enclosure which accommodates a firebox, which forms a combustion chamber and is provided with a supporting wall which supports a burner provided with a combustion head, which protrudes from the supporting wall and has a substantially cylindrical shape with an internal cavity formed axially; the enclosure is provided with a passage in which an atomizing nozzle, connected to a liquid fuel supply duct, and at least one ignition electrode are inserted from the outside; a snorkel-shaped body is also applied to the end of the combustion head that is opposite with respect to the supporting wall and the supply duct is connected supply duct is connected to a pressurized source of liquid fuel.

The present invention relates to a method for converting a gas boiler into a liquid-fuel boiler.

Gas boilers are known which comprise an external enclosure which forms a water heating chamber and accommodates internally a firebox, which exchanges heat with the water to be heated and inside which there is a combustion chamber, at one end of which there is the combustion head of a burner, which is supported by a wall of the external enclosure, typically constituted by a door for access to the combustion chamber, and is supplied with combustible gas, such as methane, LPG, biogas, and so forth.

The burners used in boilers of this type can be premix burners, which have, upstream of the combustion head, a device for premixing the combustible gas that is supplied to the combustion head with oxidizing air.

In particular, premix burners are known which are called inverterjet or inward firing burners; their combustion head has a hollow cylindrical shape capable of generating the flame at its internal wall, in which the mixture of air and gas is made to flow through a metallic mesh.

In many thermal systems, typically in those used by hospital organizations, the possibility to use liquid fuels alternative to mains gas, such as for example diesel fuel, is required for obvious safety reasons in order to ensure continuity of the heating service in case of interruption of mains gas delivery.

In order to meet this requirement in systems served by gas boilers, it is currently necessary to remove the premix gas burner from the boiler and replace it with a liquid-fuel burner, with the obvious difficulties and long labor times required for this type of intervention.

The aim of the present invention is to provide a method for converting a gas boiler into a liquid-fuel boiler that is capable of improving the background art in one or more of the aspects indicated above.

Within this aim, an object of the invention is to provide a method for converting a gas boiler into a liquid-fuel boiler that can be performed without requiring complete replacement of the burner that is already present in the boiler.

Another object of the invention is to provide a method for converting a gas boiler into a liquid-fuel boiler that allows to perform, in relatively short times and without a large use of labor, the transition from a gas supply to a liquid fuel supply in order to ensure continuity of service in the delivery of sanitary and heating hot water.

A further object of the invention is to provide a method that can be performed with instruments and accessories that are constructively simple.

This aim, as well as these and other objects which will become better apparent hereinafter, are achieved by a method for converting a gas boiler into a liquid-fuel boiler according to claim 1, optionally provided with one or more of the characteristics of the dependent claims.

Further characteristics and advantages of the invention will become better apparent from the description of a preferred but not exclusive embodiment of the method according to the invention, illustrated by way of non-limiting example in the accompanying drawings, wherein:

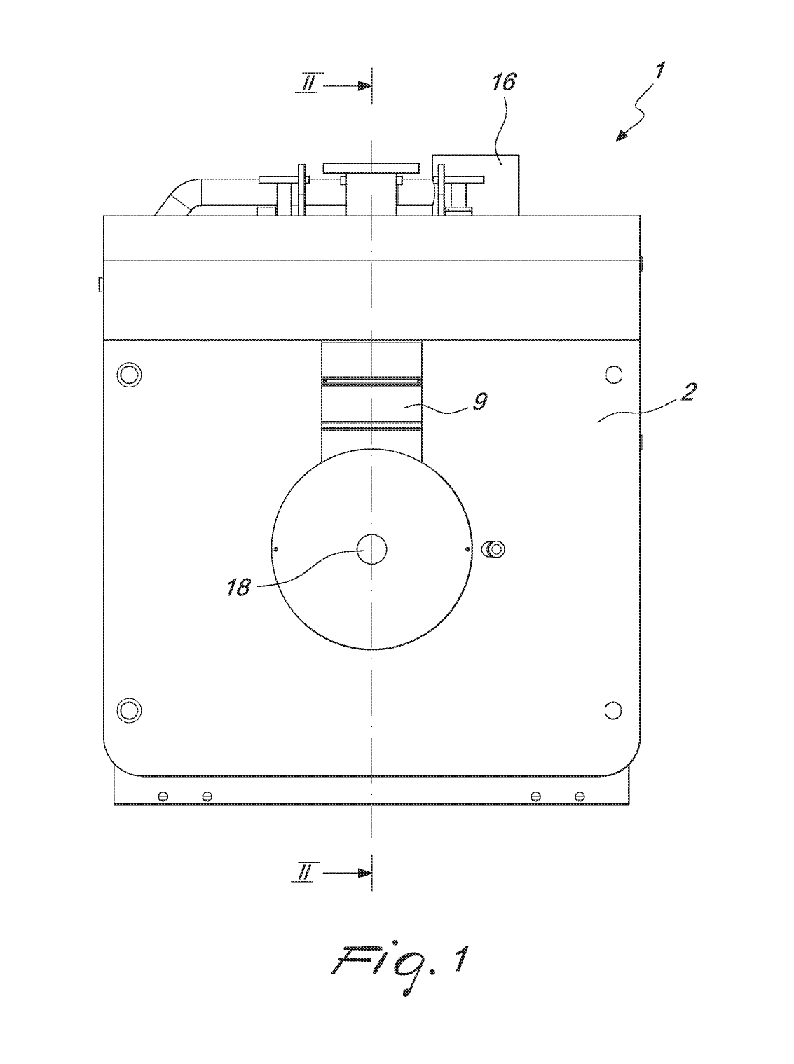

FIG. 1 is a front elevation view of a boiler that can be converted by means of the method according to the invention;

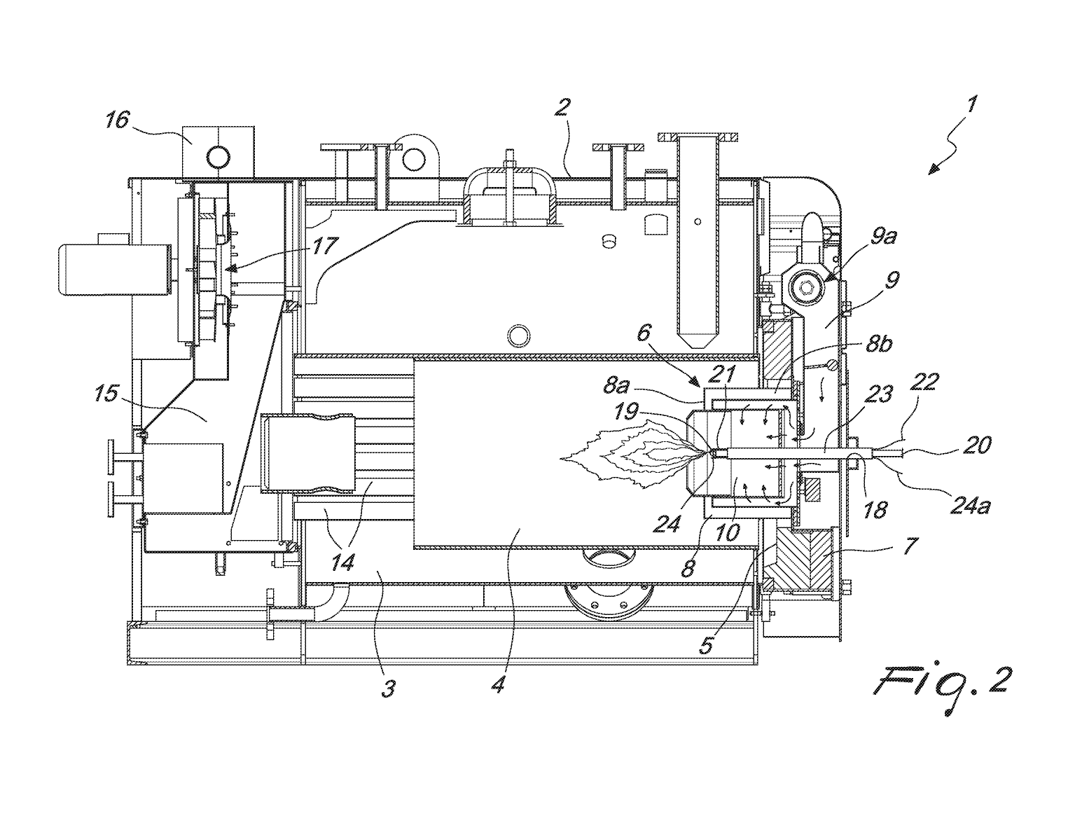

FIG. 2 is a sectional view, taken along the line II-II of FIG. 1;

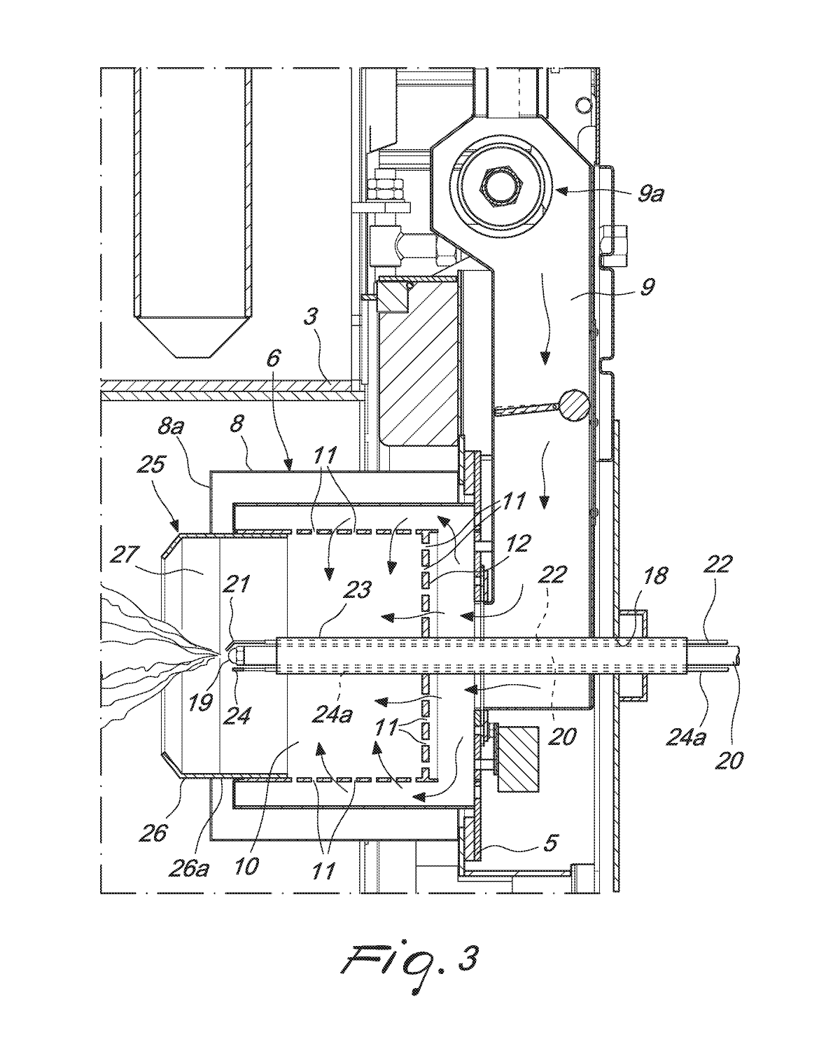

FIG. 3 is an enlarged-scale view of a detail of FIG. 2.

With reference to the figures, the method for converting a gas boiler into a liquid-fuel boiler is applied in particular to a boiler, generally designated by the reference numeral 1, which is provided with an enclosure 2, which accommodates internally a firebox 3 which forms a combustion chamber 4 and has a supporting wall 5 on which a burner 6 is mounted.

For example, the supporting wall 5 of the burner 6 can be constituted by a door 7 for closing the combustion chamber 4, which is detachable or in any case openable in order to allow access thereto from the outside.

The burner 6 comprises a combustion head 8, which is connected to a supply duct 9 of a mixture of air and gas, produced for example by means of a premixer 9a.

In particular, the combustion head 8 has a substantially cylindrical shape with a first end or free end 8a, which is directed away from the supporting wall 5, and with a second end 8b or connection end, which is opposite with respect to the free end 8a and is connected to the supporting wall 5, so that the combustion head 8 protrudes from the supporting wall 5 toward the inside of the combustion chamber 3.

The combustion head 8 is provided axially with an internal cavity 10, which is open at the free end 8a of the combustion head 8.

On its internal surface, i.e., on its surface directed toward the internal chamber 10, the combustion head 8 is provided with a plurality of dispensing openings 11, which are connected to the supply duct 9 in order to allow to generate a flame in the internal cavity 10.

Advantageously, at the second end 8b of the combustion head 8, the internal cavity 10 is at least partially closed by a bottom 12 which is provided, on its surface directed toward the internal cavity 10, with respective dispensing openings 11, which also are connected to the supply duct 9.

In the enclosure 2 of the boiler 1 there is also conveniently a containment chamber 13 for the water to be heated, which accommodates advantageously a plurality of heat exchange tubes 14 which are crossed by the combustion gases and are connected in input to the combustion chamber 4 and in output to a combustion gas collection chamber 15, which in turn communicates with a stack 16 for discharging the combustion gases externally.

Conveniently, the combustion gas collection chamber 15 accommodates a fan 17 which is adapted to place the combustion chamber 4 in partial vacuum, so as to generate a flow inside the supply duct 9.

The method according to the invention can be performed in case of interruption of the supply of gas to the premixer 9a and therefore to the supply duct 9, and entails providing the enclosure 2 and, more particularly, the supporting wall 5, with a passage 18 which is substantially aligned with the axis of the combustion head 8 and allows to connect the outside to the internal cavity 10 of the combustion head 8.

As shown, this passage 18 can optionally also pass through a portion of the supply duct 9 and can be already provided in the boiler 1, in this case remaining closed by an adapted removable plug or other, in situations of normal use with a gas supply, or can be provided on purpose, for example by providing a hole in the enclosure 2 and therefore in the supporting wall 5 and in the supply duct 9, if the boiler 1 did not have one originally.

The method according to the invention provides subsequently for inserting from the outside, through the passage 18, an atomizing nozzle 19, which is connected to a supply duct 20 of liquid fuel, such as for example diesel fuel, and at least one ignition electrode 21 for the liquid fuel, which is connected to an electric power supply cable 22.

Conveniently, in order to facilitate the insertion of the atomizing nozzle 19 and of the ignition electrode 21, a tubular guiding element 23 is introduced beforehand in the passage 18, is arranged so as to be substantially coaxial to the combustion head 8 and is then made to slide along the tubular guiding element 23, until it exits from the latter, so that the atomizing nozzle 19 and the ignition electrode 21 are in the vicinity of the free end 8a of the combustion head 8.

Advantageously, in addition to the atomizing nozzle 19 and the ignition electrode 21, it is possible to provide for the insertion, through the passage 18 and more appropriately through the tubular guiding element 23, also of one or more probes 24 for monitoring the presence of a flame, which are connected to an electric power transmission cable 24a.

After accessing the combustion chamber 3 and in particular after opening the door 7, one proceeds furthermore to apply to the free end 8a of the combustion head a snorkel-shaped body 25, which is advantageously constituted by a ring 26 which has, along its own axis, a first portion 26a, which can be coupled to the combustion head 8, and a second portion 26b, which is extended progressively toward the axis of the ring 26, proceeding in the opposite direction with respect to the combustion head 8, and is arranged outside the internal chamber 9 of the combustion head 8. A diffuser disk 27 is accommodated axially in the ring 26 and is provided for example with a plurality of wings arranged radially around the axis of the ring and inclined with respect to planes that are perpendicular to the axis of said ring. In practice, the snorkel-shaped body 25 can advantageously have the shape of an ordinary snorkel for liquid-fuel burners.

At this point, once the door 7 has been closed, the supply duct 20 is connected to a pressurized source of liquid fuel, such as diesel fuel or other, thus allowing the boiler 1 to operate by means of the liquid fuel supply.

In particular, in order to obtain the starting of the boiler 1 thus converted, the fan 17 is activated, so that air can flow in the supply duct 9 and through the dispensing openings 11 of the combustion head 8 and thus enters the internal cavity 10, so as to open the connection between the pressurized source of liquid fuel and the atomizing nozzle 19 and thus activate the ignition electrode 21, so as to ignite the liquid fuel released by the atomizing nozzle 19, thus generating a flame 30 which extends toward the combustion chamber 4.

The combustion gases produced by the flame 30 are channeled within the heat exchange tubes 14, until they reach the combustion gas collection chamber 15 and the exhaust stack 16, exchanging heat with the water contained in the containment chamber 13.

It should be noted that according to the invention a liquid-fuel burner is provided in the boiler 1 which comprises in practice the combustion head 8, which has a substantially cylindrical shape and in which the internal cavity 10 is formed axially, and is provided, on its internal surface and optionally also on the surface directed toward the internal chamber 9 of its bottom 12, with a plurality of dispensing openings 11, which are connected to a supply duct 9 which supplies the combustion head 8 with air, while axially to the combustion head there are the atomizing nozzle 19, connected to a liquid fuel supply duct 20, and an ignition electrode 21, connected to an electric power supply cable 22, and, at a free end 8a of the combustion head 8, a snorkel-shaped body 25.

In practice it has been found that the invention achieves the intended aim and objects, since it allows, in a very practical manner, to convert a gas boiler into a liquid-fuel boiler if needed.

The invention thus conceived is susceptible of numerous modifications and variations, all of which are within the scope of the appended claims; all the details may further be replaced with other technically equivalent elements.

In practice, the materials used, as well as the contingent shapes and dimensions, may be any according to the requirements and the state of the art.

The disclosures in Italian Patent Application No. 102017000106687 from which this application claims priority are incorporated herein by reference.

What is claimed is:

1. A method for converting a gas boiler into a liquid-fuel boiler, said gas boiler comprising an enclosure which accommodates a firebox, which forms a combustion chamber and is provided with a supporting wall which supports a burner provided with a combustion head, which protrudes from said supporting wall and has a substantially cylindrical shape with an internal cavity formed axially, which is open at the free end of said combustion head that is directed opposite with respect to said supporting wall and is provided, on its internal surface, with a plurality of dispensing openings connected to a supply duct which is fed with a mixture of air and gas in order to generate a flame in said internal cavity, wherein said enclosure is provided with a passage that is substantially aligned with an axis of said combustion head and is adapted to connect an outside to the internal cavity of said combustion head; a nozzle for atomizing liquid fuel, connected to a duct for supplying liquid fuel, and at least one ignition electrode connected to an electric power supply cable, are inserted from the outside through said passage; a snorkel-shaped body is applied to an end of said combustion head that is opposite with respect to said supporting wall; said supply duct is connected to a pressurized source of liquid fuel.

2. The method according to claim 1, wherein it provides, before inserting said atomizing nozzle and said ignition electrode, for introducing from the outside in said internal cavity, through said passage and substantially coaxially to said combustion head, a tubular guiding element, and for subsequently inserting in said combustion head said atomizing nozzle and said ignition electrode through said tubular guiding element.

3. The method according to claim 1, wherein it provides for the insertion in said internal cavity, through said passage, of at least one probe for checking for the presence of a flame connected to an electrical transmission cable.

4. A gas boiler comprising an enclosure, which accommodates a firebox forming a combustion chamber, and provided with a supporting wall for a burner provided with a combustion head, which has a substantially cylindrical and internally hollow shape, is connected to a duct for feeding a mixture of air and gas and has, on an internal surface thereof, a plurality of dispensing openings in order to generate a flame inside it, wherein it has, in said supporting wall, a passage that is substantially aligned with an axis of said combustion head for the insertion of an atomizing nozzle which is connected to a duct for the supply of liquid fuel and with an ignition electrode which is connected to an electric power supply cable.

5. The boiler according to claim 4, wherein said passage passes through a portion of said supply duct.

6. The boiler according to claim 4, having, inside said enclosure, a containment chamber for water to be heated which accommodates a plurality of heat exchange tubes crossed by the combustion gases and connected in input to said combustion chamber and in output to a combustion gas collection chamber which is connected to a stack for an external discharge of the combustion gases, said combustion gas collection chamber accommodating a fan which is adapted to place said combustion chamber in partial vacuum.

7. The boiler according to claim 4, wherein in said passage there is, coaxially to said combustion head, a tubular guiding element for the insertion of said atomizing nozzle and of said ignition electrode.

8. A liquid fuel burner, comprising a combustion head which has a substantially cylindrical shape with an internal cavity formed axially and is open at a first end of said combustion head and has, on an internal surface thereof, a plurality of dispensing openings connected to an air supply duct, in said internal cavity there being an atomizing nozzle, connected to a duct for the supply of liquid fuel, and an ignition electrode, connected to an electric power supply cable, a snorkel-shaped body being provided at said first end of said combustion head.

9. The burner according to claim 8, wherein at a second end of said combustion head, which is opposite with respect to said first end, said internal cavity is at least partially closed by a bottom which is provided, on its surface directed toward said internal cavity, with respective dispensing openings which are connected to said supply duct.

10. The burner according to claim 8, wherein said snorkel-shaped body comprises a ring which has a first portion which can be coupled to said combustion head and a second portion which tapers towards its axis, a diffuser disk being accommodated in said ring.
